(19) United States
(12) Patent Application Publication
(10) Pub. No.: US 2007/0205561 A1
(43) Pub. Date: Sep. 6, 2007

(54) Sealing Structure for Sliding Part

(75) Inventors: Hiroyuki Emoto, Tokyo (JP); Tetsuya Suzuki, Tokyo (JP); Tomoko Imahori, Tokyo (JP)

Correspondence Address: RABIN & Berdo, PC, 1101 14TH STREET, NW, SUITE 500, WASHINGTON, DC, 20005, US

(73) Assignee: KAYABA INDUSTRY CO., LTD., Tokyo (JP)

(21) Appl. No.: 11/632,528

(22) PCT Filed: Jul. 21, 2005
(86) PCT No.: PCT/JP05/13794

§ 371 Date: Jan. 17, 2007

(30) Foreign Application Priority Data
Jul. 22, 2004 (JP) 2004-213747

(51) Int. Cl. F16J 15/00

(52) U.S. Cl. 277/500

(57) ABSTRACT

A seal structure for a sliding part including a shaft (11) and a member (10) having a shaft hole (10a) into which the shaft (11) is inserted in a freely and relatively sliding manner, and a first packing (P1) and a second packing (P2) arranged sequentially in series from a direction in which a high pressure is applied between the shaft (11) and the shaft hole (10a). The first packing (P1) includes a sealing member (22) for sealing a space between the shaft (11) and the shaft hole (10), and a backup ring (25) disposed on a part of the side of the sealing member (22) which is in contact with a sliding surface of the shaft (11) or the shaft hole (10a), and the sealing member (22) and backup ring (25) are inseparably integrated.

### TECHNICAL FIELD

The present invention relates to a sealing structure for a sliding part of a shaft.

### BACKGROUND ART

A known conventional sealing structure for a sliding part of a shaft, in which a relatively high pressure is applied to a sliding clearance, is shown in FIG. 3 (JP2004-52854A).

A first packing 4 and a second packing 5 arranged in series are provided in order to seal a sliding clearance between a rod 2 and a cylinder 3 of a hydraulic cylinder. Each of the packing 4, 5 is fitted by insertion into a ring-shaped groove 3a, 3b provided in an inner peripheral surface of a axial hole 1 that penetrates through a cylinder end part.

The first packing 4, which is located on an inner side of the cylinder 3, i.e. the inside to which a high pressure is applied, is constituted by a sealing member 6 in the form of a U-shaped packing, and a backup ring 7 which fits into a ring-shaped notch provided at an end part of an inner periphery of this sealing member 6. Similarly, the second packing 5 is constituted by a sealing member 8 in the form of a U-shaped packing and a backup ring 9 disposed on a back surface thereof.

The sliding clearance between the rod 2 and the shaft hole 1 is sealed, and the hydraulic cylinder is maintained in an oil-tight state by respectively bringing a lip 6a and 6b of the sealing member 6 of this first packing 4 into contact with a groove bottom of the ring-shaped groove 3a and an outer periphery of the rod 2, and similarly, by respectively bringing a lip 8a and a lip 8b of the sealing member 8 of the second packing 5 into contact with a groove bottom of the ring-shaped groove 3b and an outer periphery of the rod 2.

The first packing 4 is provided to receive the high pressure within the hydraulic cylinder directly so as not to allow this high pressure to be applied to the second packing 5, and therefore, the second packing 5 is only required to seal low pressure working fluid that passes through the first packing 4. That is to say, the first packing 4 functions as a so-called buffer seal which serves to reduce the pressure applied to the second packing 5.

The sealing structure for a sliding part described above is frequently used particularly in a hydraulic cylinder for a device in which the pressure within the hydraulic cylinder is assumed to become extremely high, for example, construction equipment and the like.

### DISCLOSURE OF THE INVENTION

However, in a conventional structure, since the backup ring 7 is simply fitted from the inner peripheral side of the sealing member 6, and is not completely integrated with the sealing member 6, the working fluid may penetrate into and accumulate in the clearance between the sealing member 6 and the backup ring 7, and as a result, the backup ring 7 may become disengaged from the sealing member 6 such that the two components are displaced mutually in the rod axial direction as the rod 2 of the hydraulic cylinder performs expansion and contraction operations repeatedly over a long period of time.

Although the backup ring 7 is originally provided to prevent a heel part of the sealing member 6 from excessive deformation, the above mentioned object cannot be achieved by the disengagement of the backup ring 7.

Further, when the sealing member 6 and the backup ring 7 move within the ring-shaped groove 3a receiving the first packing 4 toward the right side of the figure and the left side of the figure, respectively, until both come into close contact with the groove side wall, the working fluid pooled in the space S returns less easily, and the oil pressure within a ring-shaped space S between the first packing 4 and the second packing 5 gradually increases.

In a normal state in which the backup ring 7 is not disengaged from the sealing member 6, the pressure within the space S is maintained in a predetermined state since the working fluid pooled in this space S returns into the cylinder through the clearance between the first packing 4 and the ring-shaped groove 3a when the pressure within the cylinder is reduced by the moving direction of the rod 2. However, when the backup ring 7 and the sealing member 6 are mutually disengaged in the axial direction, the backup ring 7 is in close contact with the left side wall of the ring-shaped groove 3a, and a lip tip end of the sealing member 6 is in similarly close contact with the right side wall, the clearance between the first packing 4 and the ring-shaped groove 3a disappears, and thus the return of the working fluid pooled in the space S becomes less feasible and as a result, the pressure within the working fluid-filled space S gradually increases.

Because this pressure is applied to a U-shaped space between the lips 8a, 8b of the sealing member 8 of the second packing 5, the lip 8b is pressed with excessive force against the outer peripheral surface of the rod 2, and as a result, the lip 8b is worn out by the motion of the rod 2 or deteriorates due to frictional heat. As a result, it may become impossible to seal the clearance between the rod 2 and the axial hole 1 suitably.

The present invention is provided to improve problems such as those mentioned above, and an object thereof is to provide a sealing structure capable of suitably sealing a sliding part of a shaft at any time.

To accomplish the above object, the present invention provides a sealing structure for a sliding part comprising a shaft, a member having a axial hole into which the shaft is inserted in a freely and relatively sliding manner, and a first packing and a second packing arranged sequentially in series from a direction in which a high pressure is applied between the shaft and axial hole, wherein the first packing comprises a sealing member for sealing a space between the shaft and the shaft hole, and a backup ring disposed on a part of the side of the sealing member which is in contact with a sliding surface of the shaft or the axial hole, and the above sealing member and the backup ring are inseparably integrated.

According to the present invention, since the sealing member and the backup ring constituting the first packing are inseparably integrated and a fluid such as the working fluid does not penetrate or accumulate between the sealing member and the backup ring, the backup ring is prevented from being disengaged from the sealing member even after repeated movement of the shaft over a long period of time. Therefore, excessive deformation of the heel part of the sealing member can be prevented, and an excellent sealing function can be maintained.

Further, since a pressure within a space between the first packing and the second packing is not increased extraordinarily by an accumulation of fluid such as the working fluid passing through the first packing inside the space, the second packing is prevented from being pressed against the sliding surface by a pressure that is greater than that required for sealing, and as a result, the second packing is avoided from being worn, and a stable sealing property thereof is maintained. Hence, excessive frictional force between the sliding surface and the second packing does not occur, and the smooth movement of the axial and so on is ensured. Further, since a function of the first packing as a buffer seal is maintained over a long period of time without deterioration, the sealing property of the second packing itself is maintained over a long period of time, resulting in an increase in the durability of both the first and second packing, and therefore a long product life can be expected.

### BRIEF DESCRIPTION OF THE DRAWINGS

FIG. 1 is an enlarged longitudinal sectional diagram of a sealing part of a hydraulic cylinder to which the sealing structure of the sliding part of the present invention is applied.

FIG. 2 is a schematic longitudinal sectional diagram of a hydraulic cylinder.

FIG. 3 is a longitudinal sectional diagram of a conventional sealing structure of a sliding part.

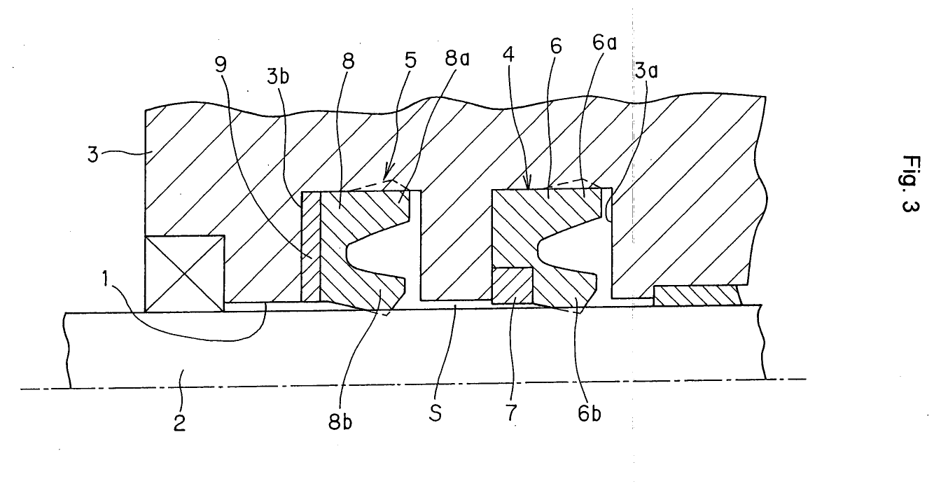

### BEST MODE FOR CARRYING OUT THE INVENTION

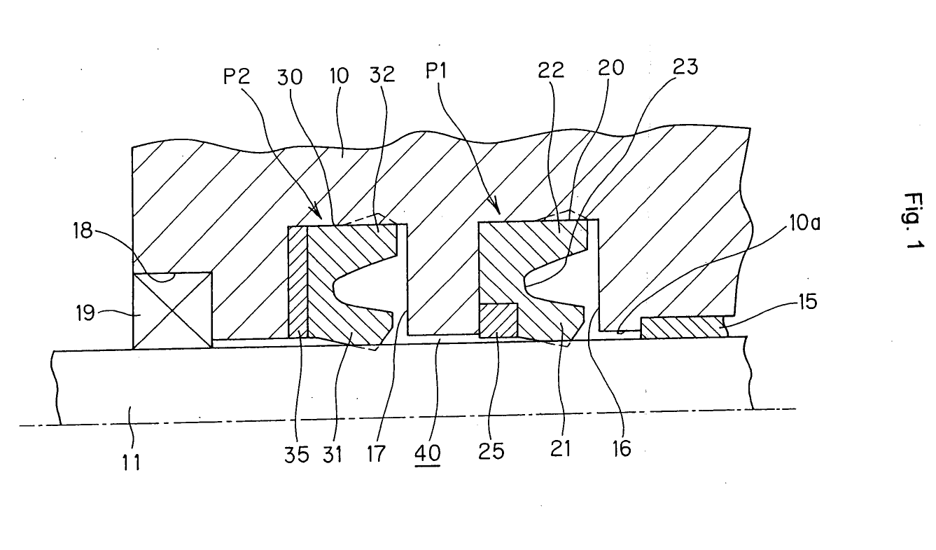

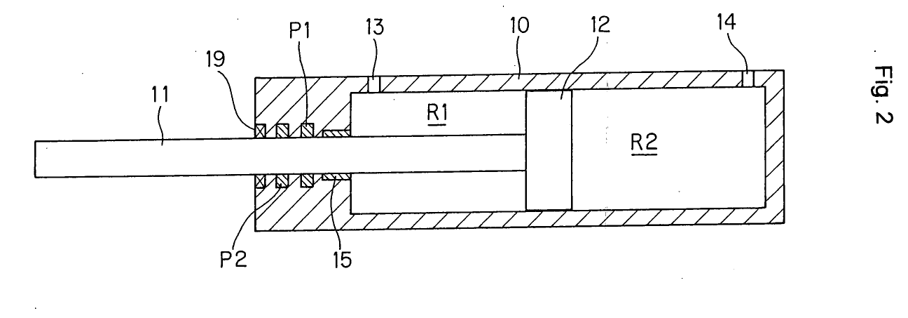

An embodiment of this invention applied to a hydraulic cylinder is described hereinafter with reference to FIG. 1 and FIG. 2.

As shown in FIG. 2, the hydraulic cylinder comprises a cylinder 10, and a piston rod 11 inserted in the cylinder 10 so as to be free to move via a piston 12. The cylinder 10 is divided into two oil chambers R1, R2 by the above piston 12, and ports 13, 14 for supplying and discharging a working fluid to and from each of the oil chambers R1, R2 are provided, each of the ports 13, 14 being selectively connected to a hydraulic pump and a reservoir through a hydraulic switching valve, not shown in the figure.

As shown in FIG. 1, the cylinder 10 is formed into a cylindrical shape having a bottom with an opening at the left end. A cylindrical shaft bearing 15 for supporting the piston rod 11 in a freely sliding manner is fitted by insertion into the nearest side to the oil chamber R1 of the through hole 10a positioned on the left end of this cylinder. Further, ring-shaped grooves 16, 17 are provided sequentially in series on the left side of the shaft bearing 15 of the through hole 10a in FIG. 1, or in other words on the inner periphery of the through hole 10a located on outer side from the oil chamber R1. A first packing P1 and a second packing P2 are fitted by insertion into the above ring-shaped groove 16 and the ring-shaped groove 17, respectively. Further, a ring-shaped notch 18 is provided on the left end of the inner periphery of the through hole 10a located on the outermost side of the oil chamber R1, and a dust seal 19 is fitted by insertion into this notch 18.

For example, this piston rod 11 contracts to the inside the hydraulic cylinder when working fluid is supplied to the oil chamber R1 through the port 13, and at the same time, the working fluid is discharged from the oil chamber R2 through the port 14. Conversely, the piston rod 11 extends from the inside of the hydraulic cylinder when the working fluid is supplied to the oil chamber R2 and discharged from the oil chamber R1.

Thus, a high pressure and a low pressure are alternately applied to the first packing P1 and the second packing P2 arranged in the clearance between the piston rod 11 and the through hole 10a, according to the movement direction of the piston rod 11.

The first packing P1 is constituted by a sealing member 20 and a backup ring 25. The sealing member 20 comprises a ring-shaped inside lip 21 that slidably contacts an outer periphery of the piston rod 11, and a ring-shaped outside lip 22 that contacts an inner periphery of the ring-shaped groove 16 formed in the cylinder 10.

The backup ring 25 is formed into a ring, and is integrated in an inseparable manner with the sealing member 20 at the end part of the inner periphery of the inside lip 21 of the sealing member 20.

It should be noted that the term “inseparably integrated”, as used herein, primarily means to be integrated so as not to cause a clearance between the sealing member 20 and the backup ring 25, and primarily means to exclude integration by simple fitting, press fitting, and the like which may cause a clearance between the sealing member 20 and the backup ring 25 by the application of oil pressure.

Further, the term “inseparable” does not primarily mean inseparable even when an excessive force or a chemical attack is exerted, but primarily means inseparable under the approximate conditions of a sealing application.

In this case, the sealing member 20 is formed into a U-packing shape at its cross section and the opening part 23 thereof faces an inner direction of the cylinder. The sealing member receives the pressure within the oil chamber R1 of the cylinder 10 at the opening part 23, and the inside lip 21 and the outside lip 22 are pressed against the outer periphery of the piston rod 11 and the groove bottom of the ring-shaped groove 16 respectively by this pressure, whereby the space between the cylinder 10 and the piston rod 11 is sealed.

The backup ring 25 is disposed so as to face the outer periphery of the piston rod 11, thereby preventing the heel part of the sealing member 20 from deforming and entering the clearance between the piston rod 11 and the through hole 10a. As a result, excessive frictional resistance between the piston rod 11 and the heel part of the sealing member 20 is prevented, and deterioration of the sealing performance due to wear on the sealing member 20 is avoided.

The above sealing member 20 is, for example, formed from thermoplastic polyurethane resins, while the backup ring 25 is formed from polyamide resins such as nylon 12 or nylon 612, for example. More specifically, those containing an amide group are preferred. In addition, the resins comprise resin compositions.

In this case, after the sealing member 20 is molded into the U-packing shape, the backup ring 25 is integrated with the sealing member 20 by thermal adhesion by injection molding polyamide resin.

Specifically, for example, a ring-shaped notch is provided in a position in the left end part of the inside lip 21 of the sealing member 20 in FIG. 1, to which the backup ring 25 is to be melt adhered. The sealing member 20 is then pre-inserted in a mold for molding the first packing P1, whereupon polyamide resin, which is the material of the backup ring 25, is injected into the above mold to fill the above notch after being heated to about 200° C. to 300° C. Thus, the backup ring 25 is molded integrally with the sealing member 20.

Thermoplastic polyurethane resin, which is the material of the above sealing member 20, and polyamide resin, which is the material of the backup ring 25, are melt adhered and integrated inseparably. When the polyamide resin serving here as the material of the backup ring 25 contains an amide group, this amide group can increase the bonding strength compared to normal melt adhesion by chemically affecting the thermoplastic polyurethane resin, and therefore the sealing member 20 and the backup ring 25 can be integrated by a strong bond.

Conversely, the sealing member 20 and the backup ring 25 may be integrated by molding the backup ring 25 into a ring shape in advance using polyamide resin, disposing the ring in the mold, and injection molding the thermoplastic polyurethane resin serving as the material of the sealing member 20, which has heated to about 200° C. to 230° C., thereafter.

In addition, when a peel strength test was conducted on the first packing P1 in accordance with JIS K6256, in the case where the nylon 12 containing an amino group heated to 200° C. is thermally adhered to the above thermoplastic polyurethane resin by injection molding, a strip specimen (13 to 14 mm in width) of the thermoplastic polyurethane resin and the nylon 12 did not peel even with a pulling force of 450 N (specifically, number of tests: 5, error: 30 N; although the test specimen was broken at 450 N on average, peeling was not observed).

When a similar peel strength test was conducted, however, by simply glueing the same materials, peeling was caused at a pulling force of approximately 60 N (specifically, number of tests: 5; error: 30 N; peeling was caused at 60 N on average). Considering the above, the bonding strength is extremely high compared to a normal glueing, solvent welding and the like. From this fact, it is advantageous that there is no need to concern about peeling even when excessive oil pressure is applied, as long as the sealing member 20 and the backup ring 25 are integrated by the above melt adhesion process.

As another embodiment, the sealing member 20 and the backup ring 25 are both formed with the thermoplastic polyurethane resins of the same-type material, provided that the material of the backup ring 25 is harder than that of the sealing member 20. The hardness is set such that the hardness of the backup ring 25 is A98 (durometer hardness), whereas the hardness of the sealing member 20 is A93 (durometer hardness), for example.

The sealing member 20 and the backup ring 25 have the same shapes as those of the above embodiment, and are produced by an identical production process.

By doing so, since the sealing member 20 and the backup ring 25 are of the same-type material, the mutual melt adhesion bonding strength thereof is increased, and the possibility of peeling decreases proportionately.

Further, an installing property upon installation of the first packing P1 into the ring-shaped groove 16 is favorable since the backup ring 25 made of thermoplastic polyurethane resin is softer than one made of polyamide resin. This is because, when installing the first packing P1 comprising the ring-shaped sealing member 20 and the backup ring 25 in the ring-shaped groove 16 in the inner periphery of the through hole 10a, it is necessary to bend the first packing P1 to pass through the through hole 10a, which has a small inner diameter, and therefore a softer material easier to be deformed is easier to install.

The above second packing P2 is a sealing member 30 in the form of a U-shaped packing comprising a ring-shaped inside lip 31 that slidably contacts the outer periphery of the piston rod 11, and a ring-shaped outside lip 32 that slidably contacts a groove bottom of a ring-shaped groove 17 formed in the cylinder 10, and further, a backup ring 35 in the form of a ring-shaped plate is disposed in the ring-shaped groove 17 on an outer side of the cylinder 10, i.e. the back surface side of the sealing member 30.

As regards the second packing P2 in particular, various materials may be selected to form it within a limit not causing any adverse effect when the space between the piston rod 11 and the cylinder 10 is sealed under relatively low pressure.

Further, a dust seal 19 is fitted by insertion in the above mentioned notch 18 for preventing the intrusion of dust or water into the cylinder 10.

In the sealing structure constructed in this manner, even when the piston rod 11 moves relative to the cylinder 10, i.e. when the hydraulic cylinder expands and contracts repeatedly over a long period of time, the working fluid does not intrude and accumulate between the sealing member 20 and the backup ring 25 since the sealing member 20 and the backup ring 25 constituting the first packing P1 are inseparably integrated.

Accordingly, since the backup ring 25 is not disengaged from the sealing member 20, the clearance in the rod axial direction between the first packing P1 and the ring-shaped groove 16 can be always secured, and therefore an excellent sealing property can be maintained since the inside lip 21 is firmly pressed against the outer peripheral surface of the piston rod 11 when a high pressure is applied to the space 23 between the inside lip 21 and the outside lip 22 of the sealing member 20 in accordance with the movement direction of the piston rod 11.

Further, since the clearance is present between the first packing P1 and the ring-shaped groove 16, the return of the working fluid that has passed through the first packing P1 and pooled in a space 40 between the first packing and the second packing P2 into the cylinder, which has been reduced in pressure by the moving direction of the piston rod 11, is not blocked.

Therefore, the pressure within the space 40 between the first packing P1 and the second packing P2 is not increased extraordinary by the accumulation of the working fluid passing the first packing P1 in the space 40. Moreover, the sealing property of the second packing P2 is not inhibited since the inside lip 31 of the second packing P2 is not worn out by being pressed against the surface of the piston rod 11 excessively and does not deteriorate due to frictional heat.

Hence, deterioration of the sealing property of the first packing P1 and the second packing P2 can be prevented, and the interior of the cylinder 10 can be maintained in a sealed state even after the repeated movement of the piston rod 11 over a long period of time Further, since the function of the first packing P1 as a buffer seal is maintained for a long period of time without deterioration, the sealing property of the second packing P2 itself is maintained over a long period of time, and consequently, the durability of the each packing P1, P2 is improved and a long product life can be expected.

Since the pressure of the working fluid applied to the inside lip 31 of the second packing P2 does not increase, the inside lip 31 is prevented from being pressed against the piston rod 11 with a force in excess of that required for sealing, and therefore, excessive frictional force between the piston rod 11 and the second packing P2 is prevented, ensuring the smooth movement of the piston rod 11.

That is to say, the smooth expansion and contraction movement of the hydraulic cylinder is ensured, and loss does not occur in the driving energy of the hydraulic cylinder.

When the melt adhesion described above is used to integrate the sealing member 20 and the backup ring 25, the glueing strength is increased, and there is no need to concern about peeling between the sealing member 20 and the backup ring 25, deterioration of the sealing property of the first packing P1 is prevented, and the durability thereof is improved. However, integration may be performed by glueing or solvent welding as long as the required strength can be obtained.

Further, in the present embodiment, the sealing structure for the sliding part is applied to the hydraulic cylinder, and therefore the ring-shaped grooves 16, 17 are provided on the cylinder 10 side and each first packing P1, P2 is fitted respectively therein by insertion. However, in a structure having a moving cylinder and a stationary shaft therein, in which a ring-shaped groove is provided on the shaft side, the backup ring 25 may be provided on the left end in FIG. 1 on the outer periphery of the outside lip 22 of the first packing P1, which contacts the inner peripheral surface of the cylinder side, and deformation of the outside lip 22 may be stopped by this backup ring 25.

Although the embodiments of the present invention has been described so far, it goes without saying that the scope of the present invention is not limited to the illustrated embodiments.

### INDUSTRIAL APPLICABILITY

The present invention can be applied as a sealing structure for a sliding part of a hydraulic cylinder and the like.

1. A sealing structure for a sliding part comprising a shaft, a member having a shaft hole into which the shaft is inserted in a freely and relatively sliding manner, and a first packing and a second packing arranged sequentially in series from a direction in which a high pressure is applied between the shaft and the shaft hole,
wherein the first packing comprises a sealing member for sealing a space between the shaft and the shaft hole, and a backup ring disposed on a part of a side of the sealing member which is in contact with a sliding surface of the shaft or the shaft hole, and
the sealing member is a resin member comprising a thermoplastic polyurethane resin, the backup ring is a resin member comprising a polyamide resin, and the sealing member and the backup ring are inseparably integrated by a melt adhesion.

2. A sealing structure for a sliding part comprising a shaft, a member having a shaft hole into which the shaft is inserted in a freely and relatively sliding manner, and a first packing and a second packing arranged sequentially in series from a direction in which a high pressure is applied between the shaft and the shaft hole,
wherein the first packing comprises a sealing member for sealing a space between the shaft and the shaft hole, and a backup ring disposed on a part of a side of the sealing member which is in contact with a sliding surface of the shaft or the shaft hole, and
the sealing member and the backup ring are both members of a same resin type of a thermoplastic polyurethane resin, provided that the backup ring is formed from a harder member than a member from which the sealing member is formed, and the sealing member and the backup ring are inseparably integrated by a melt adhesion.

3. The sealing structure for a sliding part according to claim 1, wherein the backup ring comprises nylon 12 and nylon 612.

4. The sealing structure for a sliding part according to claim 1, wherein the sealing member comprises a ring-shaped inside lip and a ring-shaped outside lip, and the backup ring is disposed on an end part of a slidably contacting surface of the inside lip or the outside lip.

5. The sealing structure for a sliding part according to claim 1, wherein the sealing member, in which a ring-shaped notch is pre-provided in a location to which the backup ring is melt adhered, is disposed inside a mold for molding the first packing, and the resin material forming the backup ring is filled into the notch by injection, thereby integrating the sealing member and the backup ring.

6. The sealing structure for a sliding part according to claim 1, wherein the backup ring, which is pre-formed into a ring shape, is disposed inside a mold for molding the first packing, and the resin material for forming the sealing member is filled into the mold by injection, thereby integrating the sealing member and the backup ring.

7. (canceled)

8. The sealing structure for a sliding part according to claim 2, wherein the sealing member comprises a ring-shaped inside lip and a ring-shaped outside lip, and the backup ring is disposed on an end part of a slidably contacting surface of the inside lip or the outside lip.

9. The sealing structure for a sliding part according to claim 3, wherein the sealing member comprises a ring-shaped inside lip and a ring-shaped outside lip, and the backup ring is disposed on an end part of a slidably contacting surface of the inside lip or the outside lip.

10. The sealing structure for a sliding part according to claim 2, wherein the sealing member, in which a ring-shaped notch is pre-provided in a location to which the backup ring is melt adhered, is disposed inside a mold for molding the first packing, and the resin material forming the backup ring is filled into the notch by injection, thereby integrating the sealing member and the backup ring.

11. The sealing structure for a sliding part according to claim 3, wherein the sealing member, in which a ring-shaped notch is pre-provided in a location to which the backup ring is melt adhered, is disposed inside a mold for molding the first packing, and the resin material forming the backup ring is filled into the notch by injection, thereby integrating the sealing member and the backup ring.

12. The sealing structure for a sliding part according to claim 4, wherein the sealing member, in which a ring-shaped notch is pre-provided in a location to which the backup ring is melt adhered, is disposed inside a mold for molding the first packing, and the resin material forming the backup ring is filled into the notch by injection, thereby integrating the sealing member and the backup ring.

13. The sealing structure for a sliding part according to claim 2, wherein the backup ring, which is pre-formed into a ring shape, is disposed inside a mold for molding the first packing, and the resin material for forming the sealing member is filled into the mold by injection, thereby integrating the sealing member and the backup ring.

14. The sealing structure for a sliding part according to claim 3, wherein the backup ring, which is pre-formed into a ring shape, is disposed inside a mold for molding the first packing, and the resin material for forming the sealing member is filled into the mold by injection, thereby integrating the sealing member and the backup ring.

15. The sealing structure for a sliding part according to claim 4, wherein the backup ring, which is pre-formed into a ring shape, is disposed inside a mold for molding the first packing, and the resin material for forming the sealing member is filled into the mold by injection, thereby integrating the sealing member and the backup ring.

16. The sealing structure for a sliding part according to claim 8, wherein the sealing member, in which a ring-shaped notch is pre-provided in a location to which the backup ring is melt adhered, is disposed inside a mold for molding the first packing, and the resin material forming the backup ring is filled into the notch by injection, thereby integrating the sealing member and the backup ring.

17. The sealing structure for a sliding part according to claim 9, wherein the sealing member, in which a ring-shaped notch is pre-provided in a location to which the backup ring is melt adhered, is disposed inside a mold for molding the first packing, and the resin material forming the backup ring is filled into the notch by injection, thereby integrating the sealing member and the backup ring.

18. The sealing structure for a sliding part according to claim 8, wherein the backup ring, which is pre-formed into a ring shape, is disposed inside a mold for molding the first packing, and the resin material for forming the sealing member is filled into the mold by injection, thereby integrating the sealing member and the backup ring.

19. The sealing structure for a sliding part according to claim 9, wherein the backup ring, which is pre-formed into a ring shape, is disposed inside a mold for molding the first packing, and the resin material for forming the sealing member is filled into the mold by injection, thereby integrating the sealing member and the backup ring.
